(19) United States
(12) Patent Application Publication
(10) Pub. No.: US 2024/0029187 A1
(43) Pub. Date: Jan. 25, 2024

(54) APPARATUS FOR POSTING IDENTIFICATION AND A METHOD FOR ITS USE

(71) Applicant: Gravystack, Inc., Phoenix, AZ (US)

(72) Inventors: Chad Willardson, Phoenix, AZ (US); Scott Donnell, Phoenix, AZ (US); Travis Adams, Phoenix, AZ (US)

(73) Assignee: Gravystack, Inc., Phoenix, AZ (US)

(21) Appl. No.: 17/873,012

(22) Filed: Jul. 25, 2022

(51) Int. Cl. G06Q 50/20; G06Q 10/10

(52) U.S. Cl. CPC G06Q 50/2057; G06Q 10/1053

(57) ABSTRACT

An apparatus for task identification is disclosed. The apparatus includes at least a processor and a memory communicatively connected to the at least a processor. The memory instructs the processor to receive a skill datum related to a user, wherein skill datum comprises a datum describing a current skill of the user. The memory additionally instructs the processor to generate a skill target as a function of the skill datum. The memory then instructs the processor to generate a pecuniary target of the user as a function of the skill target. The processor then identifies a posting as a function of the skill target. the pecuniary target using a posting machine learning model. The posting machine learning model comprises training the posting machine learning model using a posting training data. The memory then instructs the processor to display the posting using a graphical user interface.

### FIELD OF THE INVENTION

The present invention generally relates to the field of posting identification. In particular, the present invention is directed to an apparatus for posting identification and a method for its use.

### BACKGROUND

Identification of postings has long been an issue that has led to many inefficiencies. Users need postings that are tailored to their skillset and contribute to growth of that skillset. Efficient identification of these postings will provide an instant solution to an area of nee SUMMARY OF THE DISCLOSURE

In an aspect, an apparatus for task identification is disclosed. The apparatus includes at least a processor and a memory communicatively connected to the at least a processor. The memory instructs the processor to receive a skill datum related to a user, wherein skill datum comprises a datum describing a current skill of the user. The memory additionally instructs the processor to generate a skill target as a function of the skill datum. The memory then instructs the processor to generate a pecuniary target of the user as a function of the skill target. The processor then identifies a posting as a function of the skill target and the pecuniary target, wherein the posting is identified using a posting machine learning model. The posting machine learning model comprises training the posting machine learning model using a posting training data, wherein the posting training data contains a plurality of data entries containing a plurality of skill targets and a plurality of pecuniary targets as inputs correlated to a plurality of postings as an output. The posting machine learning model also comprises identifying the posting as a function of the skill target, the pecuniary target, and the posting machine learning model. The memory then instructs the processor to display the posting using a graphical user interface.

In another aspect, a method for posting identification is disclosed. The method includes receiving, using a processor, a skill datum related to a user, wherein skill datum comprises a datum describing a current skill of the user. The method additionally includes generating, using a processor, a skill target as a function of the skill datum. The method then generates, using a processor, a pecuniary target of the user as a function of the skill target. The method then identifies, using a processor, a posting as a function of the skill target, the pecuniary target, and a posting machine learning model. The method trains, using a processor, the posting machine learning model using a posting training data, wherein the posting training data contains a plurality of data entries containing a plurality of skill targets and a plurality of pecuniary targets as inputs correlated to a plurality of postings as a output. Finally, the method displays, using a processor, the posting using a graphical user interface

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for posting identification;

FIG. 2 is a block diagram of an exemplary machine-learning process;

FIG. 3 is a block diagram of an exemplary embodiment of a posting database;

FIG. 4 is a diagram of an exemplary embodiment of neural network;

FIG. 5 is a diagram of an exemplary embodiment of a node of a neural network;

FIG. 6 is a graph illustrating an exemplary relationship between fuzzy sets;

FIG. 7 is a block diagram of exemplary embodiment of an immutable sequential listing;

FIG. 8 is a flow diagram of an exemplary method for posting identification; and

FIG. 9 is a block diagram of a computing system that can be used to implement any one-off the drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for an apparatus for task identification. The apparatus includes at least a processor and a memory communicatively connected to the at least a processor. The memory may instruct the processor to receive a skill datum related to a user, wherein skill datum comprises a datum describing a current skill of the user. The memory may additionally instruct the processor to generate a skill target as a function of the skill datum. The memory may then instruct the processor to generate a pecuniary target of the user as a function of the skill target. The processor may then identify a posting as a function of the skill target and the pecuniary target, wherein the posting is identified using a posting machine learning model. The posting machine learning model may comprise training the posting machine learning model using a posting training data, wherein the posting training data contains a plurality of data entries containing a plurality of skill targets and a plurality of pecuniary targets as inputs correlated to a plurality of postings as a output. The posting machine learning model may also comprise identifying the posting as a function of the skill target and the pecuniary target. The memory may then instruct the processor to display the posting using a graphical user interface. Exemplary embodiments illustrating aspects of the present disclosure are described below in the context of several specific examples.

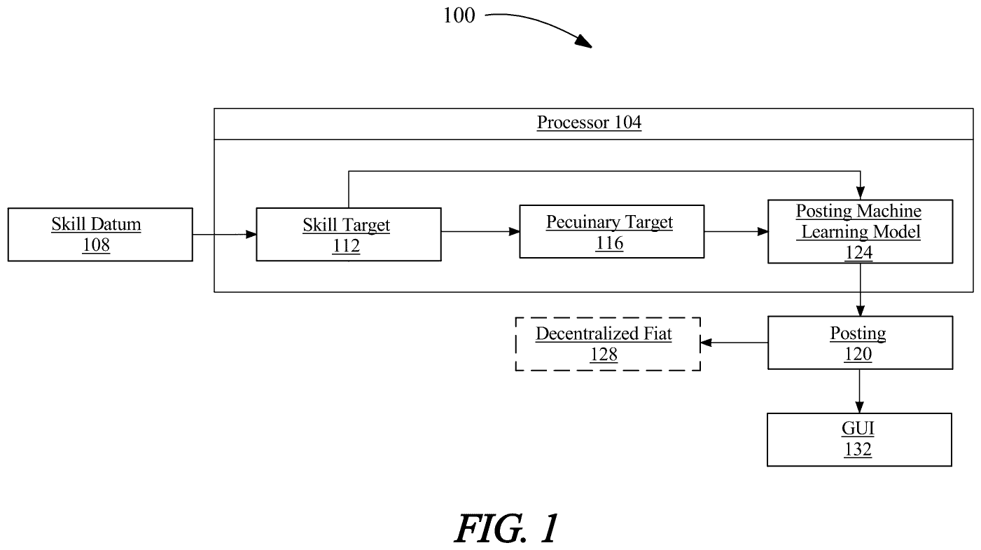

Referring now to FIG. 1, an exemplary embodiment of an apparatus 100 for an apparatus for posting identification and a method for its use is illustrated. Apparatus 100 includes a Processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting Processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of system 100 and/or computing device.

With continued reference to FIG. 1, Processor 104 may be designed and/or configured to perform any method, method step, or sequence of method steps in any embodiment described in this disclosure, in any order and with any degree of repetition. For instance, Processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 104 may be configured to receive skill datum 108. As used in the current disclosure, “skill datum” is an element of data related to the current skill of the user. As used in the current disclosure, a “current skill” is a skill level of the user at the time of recordation. Examples of user skill datum 108 may include data describing athletic skill, academic skill, vocational skill, financial skill, musical skill, and the like. In a non-limiting example, skill datum 108 may include the user's ability to complete a job or task. In another non-limiting example, the skill datum 108 may include the user's ability to apply his/her trade or craft such as welding, plumbing, or electrical work, healthcare work, and the like. Skill datum 108 may also include a user's physical fitness in terms of his or her capabilities to do manual labor. Skill datum 108 may additionally account for the users academic background. This may include both formal and informal education. A non-limiting example of academic skill may be the user's education such as a high school diploma, PhD, Bachelor of Science, Master's degree, and the like. A non-limiting example of academic skill may be the user's vocational education such as any professional certification or license.

With continued reference to FIG. 1, skill datum 108 may be generated by a plurality of sensors. As used in this disclosure, a “sensor” is a device that is configured to detect a phenomenon and transmit information related to the detection of the phenomenon. For example, in some cases a sensor may transduce a detected phenomenon, such as without limitation, current, speed, direction, force, torque, moisture, temperature, pressure, geographic location, the physical state of the user, biometric identifiers, and the like, into a sensed signal. Sensor may include one or more sensors which may be the same, similar, or different. Sensor may include one or more sensor suites with sensors in each sensor suite being the same, similar, or different. A sensor may be located within a user device. A user device includes a tablet, laptop, smartphone, and the like. A phenomenon a sensor is configured to detect may be a skill datum 108. This may include detecting athletic skill, academic skill, vocational skill, financial skill, musical skill, and the like. This may be done using one or more sensors. In an embodiment, a sensor may be configured to detect a user's work product this may be done to detect the user's vocational skill or academic skill. A user's work product may include any activity that a user during the course and scope of their vocational or academic studies or jobs. The senor may be configured This may include a detection of the user's ability to complete a job or task. In another embodiment, a sensor may be configured to detect the users financial records (i.e. bank records, credit cards, assets, etc.) to detect the user's financial skill. A Senor may be configured to detect a physiological parameter to detect the athletic skill of the user. At least a sensor may be configured to detect at least a physiological parameter. As used in the current disclosure, a “physiological parameter” includes detection of any datum describing a physiological state of user. As used in the current disclosure, a “physiological state” is a physical condition associated with the user. The Physiological state may be associated with a data element describing the users physical or mental health.

Still referring to FIG. 1, a sensor may be configured to detect a user's work product using an optical character recognition (OCR). This detection may comprise convert of images of written (e.g., typed, handwritten or printed text) into machine-encoded text. In an embodiment, a OCR sensor may be used to detect a user's written work product. In some embodiments, a processor 104 may assign a uniform task in the users given field of work. Examples of uniform tasks may include writing assignments, academic assignment, written vocation assignments, quizzes or tests based on the users vocation and the like. Examples of written work product may include any hand written writing samples, spreadsheets, digital writing, word documents, PDFs, and the like. The written work products may be converted into machine encoded text where processor 104 may be evaluated for their content against a plurality or previous users written work product who engaged in the same or similar uniform task. The users work product may receive a numerical ranking. This ranking and the results of the uniform task assigned by processor 104 may be included within skill datum 108.

Still refereeing to FIG. 1, in some embodiments, optical character recognition or optical character reader (OCR) includes automatic conversion of images of written (e.g., typed, handwritten or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases OCR may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases. a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

Still referring to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

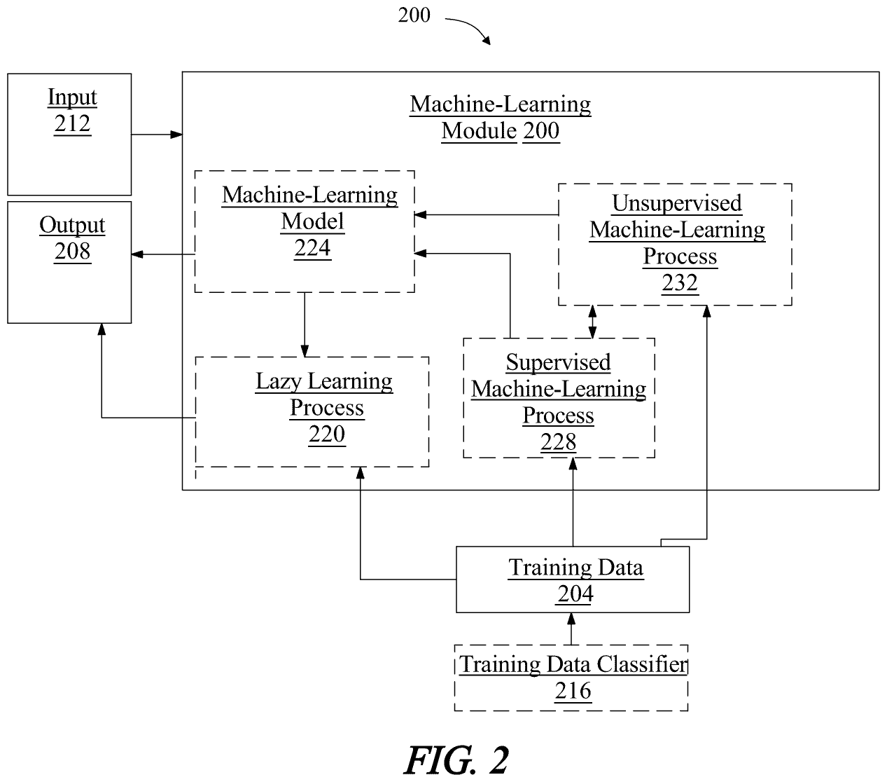

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIG. 2. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

Still referring to FIG. 1, at least a sensor may include a plurality of sensors. In an embodiment, sensor may include temperature sensor, brain activity sensors, pressure sensors, skin sensors, heart rate sensor, blood pressure sensor, sweat sensor, resistance sensor, voltage sensor, multimeters, rental sensor, facial recognition, a camera, image sensor, and the like. In an embodiment, a sensor may be used to input text into processor 104. This may be done using Optical character recognition. As used in the current disclosure, “Optical character recognition” is the electronic conversion of images of typed, handwritten, or printed text into machine-encoded text. In embodiments, a sensor may whether from a scanned document, a photo of a document, a scene-photo or from subtitle text superimposed on an image. In an embodiment, an optical character sensor may be used to transcribe any writing of the user into a digital signal.

With continued reference to FIG. 1, a processor 104 may receive skill datum 108 from a wearable device which generates wearable device data. As used in the current disclosure, a “wearable device” is a computing device that is designed to be worn on a user's body or clothing. The wearable device may detect wearable device data. In embodiments, a wearable device may include a smart watch, smart ring, fitness tracking device, and the like. As used in the current disclosure, “wearable device data” is data collected by a wearable device. Wearable device data may include data and associated analysis corresponding to, for instance and without limitation, accelerometer data, pedometer data, gyroscope data, electrocardiography (ECG) data, electrooculography (EOG) data, bioimpedance data, blood pressure and heart rate monitoring, oxygenation data, biosensors, fitness trackers, force monitors, motion sensors, video and voice capture data, social media platform data, and the like. Wearable device data may be provided by a user or a second individual on behalf of a user, for instance and without limitation a physician, medical professional, expert, cohort, and the like.

With continued reference to FIG. 1, apparatus 100 may generate skill datum 108 from survey data. As used in the current disclosure, “survey data” is an element of data that is generated from a series of answers to questions by the user, cohort, or expert. The survey data may include responses to a user survey given to a user. The survey may include questions regarding the user's athletic activity, academic activity, vocational activity, financial activity, nutritional activity, musical activity, and the like. The survey data may be used at various points by apparatus 100. For example, the survey data may be a component of skill datum 108. In some embodiments, survey data may be used to generate skill datum 108, cohort datum, and/or expert datum.

Further referring to FIG. 1, in some embodiments, skill datum may be received as text reported by user and/or another person, whether entered using a survey, scanned from written text using OCR, or the like; for instance, a person having expertise in an area may provide text representing an opinion regarding a user's skill; opinion may include, without limitation, a label of a linguistic variable representing a general skill level, or the like. Alternatively or additionally, skill datum may be determined using sensor input and/or other data input using one or more processes for determination of skill data from inputs. For example, physiological data may be combined with data describing an activity performed, such as distances covered in a run or other activity captured by a wearable device, to determine a degree of physical fitness. As a further non-limiting example, financial data such as a series of transactions, balances, or the like, may be used to determine a degree of financial skill and/or literacy.

Still referring to FIG. 1, determinations may be made, without limitation, by retrieval of skill levels from a database and/or data structure associating various inputs with skill data. Alternatively or additionally, skill datum may be determined by determination of a strength or weakness of user regarding one or more skills as determined according to processes described in U.S. nonprovisional application Ser. No. 17/872,857, filed on Jul. 25, 2022, entitled “APPARATUS AND METHODS FOR ANALYZING STRENGTHS,” and filed with attorney docket number 1325-007USU1, in U.S. nonprovisional application Ser. No. 17/872,950, filed on Jul. 25, 2022, entitled “APPARATUS AND METHODS FOR ANALYZING DEFICIENCIES,” and filed with attorney docket number 1325-008USU1, each of which is incorporated by reference herein in its entirety.

With continued reference to FIG. 1, processor 104 may be configured to generate a skill target 112 as a function of skill datum 108. As used in the current disclosure, a “skill target” is level or improvement of skill a user would like to achieve. A skill target 112 may additionally be generated as a function of a skill rank of one or more past users; skill rank is described in greater detail herein below. A skill rank of a plurality of past users may be used to identify the level of proficiency in a given skill that the previous user possessed, as a function of his/her skill datum 108. Once the skill rank of the plurality of previous users is identified the skill ranking may be paired to a pecuniary target 116. A skill rank of the plurality of previous users may also be paired to the previous postings 120 of the previous user. The wage index of the previous users may also be identified as a function of the postings 120, skill rank, and pecuniary targets 116. Once the skill rank, pecuniary target 116, and posting 120 of the previous users have been identified a skill target for the current user may be generated. The plurality of previous users may be sorted as a function of the desired pecuniary target 116 or posting 120. Skill rankings of the plurality of previous users that have the desired pecuniary targets, wage index, or posting, may be averaged to produce a skill target. 112 for the current user. A skill target 112 may be generated by looking it up in a data structure as a function of a skill datum 108. An example of a data structure may include a database. Another example of a data structure may include a graph connecting nodes representing current skill levels versus a target skill level. A skill target 112 may also be generated by using a target machine learning model. In a non-limiting example, a previous user A, B, and C may be identified to have a skill rank of 7, 9, and 3, respectively. Processor 104 may identify that the previous users had a pecuniary target 116 of $80,000 for A, $100,000 for B, and $45,000 for C, respectively, Processor 104 may sort the users as a function of a pecuniary targets 116 over $60,000 leaving only user A and B. The skill rank of user A and B may be averaged to produce a skill target of 7 for the current user.

With continued reference to FIG. 1, a skill target 112 may an improvement of athletic skill, academic skill, vocational skill, financial skill, musical skill, and the like which the user would like to improve. As used in the current disclosure, a “vocational skill” is a skill that is related to improving a user's skill in his/her career. As used in the current disclosure, a “pecuniary skill” is a skill that is related to improving a user's pecuniary position. As used in the current disclosure, a “pecuniary literacy” is a skill that involves improving the user's knowledge of his or her pecuniary position. As used in the current disclosure, an “educational skill” is a skill used to improve the users formal or professional education. Examples of skill target 112 may include starting a new career, developing new vocational skill, improving budget management skills, advancing current vocational skills, furthering the user's education, improving a user's overall health and fitness, and the like. In a further non-limiting example, the processor 104 may generate an educational target for the user of getting a college degree. In another non-limiting example, the processor may generate a skill target 112 for the user to save a predetermined amount of money. A user may be assigned a plurality of a skill targets 112 as a function of a user input. A skill target 112 may be generated using a target machine learning model or as a function of survey datum.

With continued reference to FIG. 1, processor 104 may be configured to generate a skill target 112 using a target machine learning model. As used in the current disclosure, a “target machine learning model” is a mathematical and/or algorithmic representation of a relationship between inputs and outputs. A target machine learning model may be implemented in any manner described in this disclosure regarding implementing and/or training machine learning models. Inputs to the machine learning model may include, as a non-limiting example, skill datum 108, previous skill targets 112, previous postings 120, previous pecuniary target 116, any combination thereof, or the like. Inputs to the machine learning model may be received from a database, such as posting database 300. Previous postings 120, previous skill targets 112, and/or previous pecuniary targets 116 may come from the current user or users similarly situated to the users by user interest, user skill, pecuniary status, and/or aptitude for task completion. Target machine learning model may by trained using target training data. Target training data may include a plurality of data entries containing a plurality of inputs that are correlated to a plurality of outputs for training a processor 104 by a machine-learning process. Target training data may correlate a plurality of skill data 108 of as inputs to a plurality of skill targets as a output. Target training data may correlate a previous skill target 112 as a input to a plurality of skill targets as an output. Target training data may correlate a previous postings 120 and a previous pecuniary target 116 as inputs to a plurality of skill targets as an output. Target training data may include skill datum 108, previous skill targets 112, previous postings 120, previous pecuniary target 116, any combination thereof, or the like. Target training data may be generated as a function of a user input, past skill levels, past inputs of target machine learning model, past performance on postings of the user, and the like. Target training data may be stored in a database, such as a training data database, or remote data storage device, or a user input or device.

With continued reference to FIG. 1, processor 104 may generate a skill improvement datum as a function of skill datum 108. As used in the current disclosure, “skill improvement datum” is a set of instructions configured to augment skill datum 108 in a manner favorable to the user. A skill improvement datum may be generated using skill rank of the user, a skill rank is described in greater detail herein below. A skill rank may be used to identify the a current skill which the user needs to improve. Identification may occur through a determination that the skill rank of a current skill or skill datum 108 is below a threshold. A skill improvement datum may then search through a database or other data structure for instructions to improve the current skill as a function of the identification. These instructions may be displayed to the users using a GUI. Improvement of skill datum 108 or current skill may be measured by improvement to the users skill rank. A determination of favorable results for the user may be generated via survey data or user input. A person reasonably skilled in the art may understand what a favorable result is. A skill improvement datum may encompass an evaluation of skill datum 108 and skill rank. In an embodiment, skill improvement datum may include a plurality of tasks that will augment skill datum 108 in a favorable manner. This may also include one or more remedial tasks such as educating the user regarding the cause of the undesirable skill datum 108. Skill improvement datum may be generated as a function of a skill rating. In a non-limiting example, a skill improvement datum may suggest drills or tasks that will help the users skill rating improve from a 4 to a 7. A skill improvement datum may additionally suggest areas where a user improve their skill datum 108 or improve efficiency in application of their skill datum 108. This may include time saving suggestions, material saving suggestions, technique suggestions, and the like. A non-limiting example of skill improvement datum may include instructions about how to reduce a undesired actions.

With continued reference to FIG. 1, processor 104 may be configured to generate a pecuniary target 116 as a function of skill target 112. As used in the current disclosure, a “pecuniary target” is a estimation of the income a user will earn if they achieve a skill target 112. In an embodiment, a pecuniary target 116 may be a wage index. A pecuniary target 116 may be generated as a function of skill target 112. A pecuniary target 116 may be generated by looking it up in a data structure as a function of a skill target 112. An example of a data structure may include a database. Another example of a data structure may include a graph connecting nodes representing current skill levels versus a target skill level. A pecuniary target 116 may also be generated by classifying a skill target to a pecuniary target using a pecuniary classifier. In a non-limiting example, a pecuniary target 116 may be an prediction that a user will make 35$ per hour if they achieve a skill target 112 of getting a vocational skill such as obtaining a commercial driver's license. In another non-limiting example, a pecuniary target 116 may a range of 35-50$ dollars per hour if the users achieves a skill target 112 of gaining a nurses license.

With continued reference to FIG. 1, processor 104 may be configured to generate a pecuniary target 116 as a function a classification of a skill target 112 to one or more pecuniary target 116. As used in the current disclosure, a “pecuniary classifier” is a machine-learning model that sorts inputs into categories or bins of data, outputting the categories or bins of data and/or labels associated therewith. Pecuniary classifier may be consistent with the classifier described below in FIG. 2. Inputs to the to the pecuniary classifier may include, as a non-limiting example, skill datum 108, skill targets 112, previous postings 120, previous pecuniary target 116, any combination thereof, or the like. The output to the pecuniary classifier may be a pecuniary target 116 that is specific to the given user. Pecuniary training data is a plurality of data entries containing a plurality of inputs that are correlated to a plurality of outputs for training a processor by a machine-learning process to align and classify a user's pecuniary target 116 to a skill target 112. Pecuniary training data may be received from a database. Pecuniary training data may contain information about, as a non-limiting example, skill datum 108, skill targets 112, previous postings 120, previous pecuniary target 116, any combination thereof, or the like. Pecuniary training data may be generated from any past user pecuniary targets, pecuniary datum 108, pecuniary plans 112, and the like. Pecuniary training data may correlate an example of a skill target 112 to an example of a pecuniary targets 116. The “example of a pecuniary target” and the “example of skill target” may be prior a prior skill targets 112 and a pecuniary targets 116, respectively. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, a classifier, such as pecuniary classifier, may be implemented as a fuzzy inferencing system. As used in the current disclosure, a “fuzzy inference” is a method that interprets the values in the input vector (i.e., pecuniary target 116 and a skill target 112.) and, based on a set of rules, assigns values to the output vector. A set of fuzzy rules may include a collection of linguistic variables that describe how the system should make a decision regarding classifying an input or controlling an output. An example of linguistic variables may include variables that represent a pecuniary target. Examples of this may include two variables, one representing an amount of money and a second variable representing a posting 120. A non-limiting example of this may be posting 120 as a nurse practitioner earning $150,000 per year. A linguistic variable may also include a variable representing a skill target 112. An example of this may include “proficient,” “satisfactory,” “unsatisfactory,” “exceptional,” adequate,” “inadequate,” and the like. A fuzzy set may also be used to show degree of match between fuzzy sets may be used to rank one resource against another. For instance, if both skill target 112 and pecuniary target 116 have fuzzy sets, a skill target 112 and pecuniary target 116 may be matched to a posting 120 by having a degree of overlap exceeding a predictive threshold, processor 104 may further rank the two resources by ranking a resource having a higher degree of match more highly than a resource having a lower degree of match.

With continued reference to FIG. 1, a pecuniary target 116 may include a consideration of a wage index. As used in the current disclosure, a “wage index” is an estimated range of monetary compensation an employee will receive for a given position. For example, monetary compensation may include cash, stock options, cryptocurrency, benefits, retirement contributions, insurance, and the like. Monetary compensation may include wages, overtime wages, salary, piece work rate, commission, bonus, tips, and the like. In some embodiments, a desired wage index may be input into a processor 104 by a user. In other embodiments, a wage index may be input into a processor 104 by a candidate or an employer based on a posting 120. Wage index may be calculated based on a pecuniary target 116 or a skill target 112. In an embodiment, a wage index of a posting 120 may be used to generate a pecuniary target 116. A user's pecuniary target 116 may be configured to be within the wage index of a postings 120. A user's pecuniary target 116 may also be configured to be within the average wage index of a plurality of posting 120. Processor 104 may be configured to take the average of a plurality of wage indexes to generate a pecuniary target 116. A processor 104 may generate a pecuniary target 116 by classifying a wage index to a pecuniary target 116. In a non-limiting example, a user may have postings 120 to have a wage index of $75,000-$95,000. A pecuniary target 116 of $85,000 per year may be selected as a function of the wage index because $85,000 is the median salary within the wage index. In another non-limiting example, a user may be paired to two or more postings 120. The respective postings 120 may have an average wage index of $110,000-$140,000. A pecuniary target 116 of $125,000 per year may be selected as a function of the average of the plurality of wage indexes because $125,000 is the median salary within the averages of wage index. In an embodiment, a pecuniary target 116 may be identified as a function of a wage index is being within a certain of the pecuniary target. In another embodiment, both a wage index and a pecuniary target may be represented as fuzzy sets. A pecuniary target 116 specific to the user may be represented as the intersection of the two fuzzy sets. In another embodiment. a machine learning model may be configured to correlate a wage index as an input to a pecuniary target 116 as an output. A machine learning model may be consistent with any machine learning model mentioned within the current disclosure. A wage index may also be calculated based on the availability of candidates or postings 120. Wage index may also be calculated based on the monetary compensation of users whose experience, qualifications, and education are similar to the current candidate.

With continued reference to FIG. 1, processor 104 may be configured to identify a posting 120 as a function of the skill target 112, the pecuniary target 116, and the posting machine learning model 124. For the purpose of this disclosure, “posting” is information related to an available and/or open job position. For the purposes of this disclosure, a “job position” (also referred to in this disclosure as a “job”) is a paid occupation with designated tasks associated therewith. A job position may include an employment with an employer, such as work as an employee (part-time or full-time), intern, worker, contractor, self-employed, and the like. For example, and without limitation, posting 120 may include information and/or data from a job posting and/or listing that describes an open job position. Posting 120 may include a job position title, qualifications and/or requirements for the job position, expected responsibilities associated with the job position, benefits with the job position, wage index, geographical location, employer information, and the like. Posting 120 may include information related to an employer's expectations of a person hired for such a job position. For instance, and without limitations, posting 120 may include minimum qualifications that a candidate must possess to adequately perform the job position. Qualifications for job position may include education, certification, experience, desired skills and/or abilities, personal qualities, and the like. Posting 120 may also include information that a person hired for the job position may expect from the job position. For instance, and without limitation, posting 120 may include working hours for the job position, a type of salary, degree of professionalism, and the like. In one or more embodiments, posting 120 may include a datum or a plurality of data related to an available job.

With continued reference to FIG. 1, processor 104 may be configured to identify a posting 120 for the user as a function of geographic datum. As used in the current disclosure, “geographic datum” is an element of datum used to identify a posting 120 based on a pre-determined geographic area. Geographic datum may be generated via user input or the use of a GPS tracker or a sensor. This may be done using a device such as a computer, smartphone, laptop, tablet, and the like. Geographic datum may group users and postings 120 as a function of their geographic proximity. In embodiments, Geographic proximity may include any radius from a given point. Geographic proximity may also include a city, county, state, zip code, area code, and the like. For example, a user may only qualify for postings 120 that are in New York City as a function of a geographic datum indicating the user is living in New York City.

With continued reference to FIG. 1, processor 104 may be configured to identify a posting 120 for the user as a function of cohort datum. As used in the current disclosure, “cohort datum” is an element of data used to identify a category or a group of user to which the user belongs. Cohort datum may include a user that is grouped by skill, geography, wage index, posting, and the like. A Cohort datum may be generated as a function of survey datum. Wherein a members of the cohort may be required to answer a plurality of questions regarding the type of posting 120, wage index, pecuniary target that a user desires. A processor 104 may use the cohort datum to identify a posting 120 by classifying a posting to the cohort the user is a part of.

With continued reference to FIG. 1, processor 104 may be configured to generate a cohort datum as a function a classification of a posting to one or more members of a cohort. As used in the current disclosure, a “cohort classifier” is a machine-learning model that sorts inputs into categories or bins of data, outputting the categories or bins of data and/or labels associated therewith. Cohort classifier may be consistent with the classifier described below in FIG. 2. Inputs to the to the pecuniary classifier may include, as a non-limiting example, examples of posting 120, skill datum 108, skill target 112, pecuniary target 116, wage index, skill rank, geographical datum, examples of cohort datum, expert datum, any combination thereof, or the like. The output to the cohort classifier may be a cohort datum that is specific to the given user. Cohort training data is a plurality of data entries containing a plurality of inputs that are correlated to a plurality of outputs for training a processor by a machine-learning process to align and classify a user's cohort datum to a posting 120. A cohort training datum may be configured receive a cohort datum as an input and classify it to a posting 120 as an output. Cohort training data may be received from a database. Cohort training data may contain information about, as a non-limiting example, examples of posting 120, skill datum 108, skill target 112, pecuniary target 116, wage index, skill rank, geographical datum, examples of cohort datum, expert datum, any combination thereof, or the like. Cohort training data may be generated from any past user pecuniary targets, pecuniary datum 108, pecuniary plans 112, and the like. Cohort training data may correlate an example of a cohort datum to an example of a posting 120. The “example of a cohort datum” and the “example of posting” may be prior a prior posting 120 and cohort datum 116, respectively. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, processor 104 may be configured to identify a posting 120 for the user as a function of expert datum. As used in the current disclosure, “expert datum” is an element of datum used to identify a posting 120 based on the determination of an expert in the same field of the posting 120. In an embodiment, expert datum may be generated by an expert in the same field as the user is skilled in. In an embodiment, an expert may include any professional in the given an athletic field, a medical field, academic field, vocational field, financial field, musical field, and the like. In an embodiment, an expert may designate a that users skill datum 108 is adequate to accomplish a skill target 112. Processor 104 may be configured to receive expert datum and identify it to a posting by classifying it to said posting 120. A processor 104 may be configured to lookup a posing 120 in a database or other data structure as a function of expert datum. In a non-limiting example, a posting 120 may be configured to be identified within a database as a function of the determination of the expert based on the skill target 112 of the user. In another embodiment, an expert may designate a that once a user reaches a skill target 112, he/she is qualified for a given posting 120. Expert datum may identify a posting 120 a user is qualified for as a function of skill datum 108, Skill target 112, and/or pecuniary target 116.

In one or more embodiments, posting 120 may be provided to or received by processor 104 using various means. In one or more embodiments, posting 120 may be provided to processor 104 by a user, such as an employer or human resources professional that is interested in hiring for a job position by the employer of the job position. A user may manually input posting 120 into processor 104 using, for example, a graphic user interface 132 and/or an input device. For example, and without limitation, a user may use a peripheral input device to navigate graphic user interface and provide posting 120 to processor 104. Non-limiting exemplary input devices include keyboards, joy sticks, light pens, tracker balls, scanners, tablet, microphones, mouses, switches, buttons, sliders, touchscreens, and the like. In other embodiments, posting 120 may be provided to processor 104 by a database over a network from, for example, a network-based platform. Posting 120 may be stored in a database and communicated to processor 104 upon a retrieval request form a user and/or from processor 104. In other embodiments, posting 120 may be communicated from a third-party application, such as from a third-party application on a third-party server, using a network. For example, posting 120 may be downloaded from a hosting website for job listings. In one or more embodiments, processor 104 may extract posting 120 from an accumulation of information provided by a database. For instance, and without limitation, computing device may extract needed information from database regarding the job position and avoid taking any information determined to be unnecessary. This may be performed by processor 104 using a machine-learning model, which is described in this disclosure further below.

With continued reference to FIG. 1, processor 104 may be configured to identify posting 120 using a posting machine learning model 124. As used in the current disclosure, a “posting machine learning model” is a mathematical and/or algorithmic representation of a relationship between inputs and outputs. A posting machine learning model 124 may be implemented in any manner described in this disclosure regarding implementing and/or training machine learning models. Inputs to the machine learning model may include, as a non-limiting example, posting 120, skill datum 108, skill target 112, pecuniary target 116, wage index, skill rank, geographical datum, cohort datum, expert datum, any combination thereof, or the like. Inputs to the machine learning model may be received from a database, such as posting database 300. Previous postings 120 may come from the current user or users similarly situated to the users by user interest, pecuniary status, and/or aptitude for task completion. Posting machine learning model 124 may by trained using posting training data. Posting training data may include a plurality of data entries containing a plurality of pecuniary targets as inputs that are correlated to a plurality postings as outputs for training a processor 104 by a machine-learning process. Posting training data may include previous posting 120, skill datum 108, skill target 112, pecuniary target 116, wage index, skill rank, geographical datum, cohort datum, expert datum, and the like. Posting training data may be generated as a function of a user input, past skill levels, past inputs of posting machine learning model 124, past performance on postings of the user, and the like. Posting training data may be stored in a database, such as a training data database, or remote data storage device, or a user input or device.

Still referring to FIG. 1, processor may be configured to generate a machine learning model, such as posting machine learning model 124, using a Naive Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(AB) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number experience of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Still referring to FIG. 1, a skill ranking may be generated as a function of a skill datum. As used in the current disclosure, a “Skill Ranking” is a ranking of how proficient a user in a given skill as a function of skill datum 108. A skill ranking may include a ranking of a user's skill datum 108 or current skill. A skill ranking may be calculated on a scale from 1-10, wherein a rating of 1 may be a unskilled whereas a rating of 10 may be an expert in the area of skill. A skill ranking may be generated from skill datum 108. A skill ranking may be used to generate a skill target. In an non-limiting example, a user may have a skill ranking of a 5, as a function of this skill ranking a skill target may be established to achieve a skill ranking of 7. In some embodiments, a skill ranking may be used to identify a posting for the user. Users with a higher skill ranking may be paired with postings with higher wage indexes or salaries. In some embodiments, generating the skill ranking may include linear regression techniques. Processor 104 may be designed and configured to create a machine-learning model using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm mounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

With continued reference to FIG. 1, processor 104 may be configured to generate a decentralized fiat 128 as a function of completion of a skill target 112, posting 120, or a pecuniary target 116. As used in the current disclosure, a “decentralized fiat” is a bank-free method of transferring wealth or ownership of any other commodity without needing a third party. Decentralized fiat may include a non-fungible token or various crypto currencies. A “non-fungible token,” as used in this disclosure, is a unique and non-interchangeable unit of data stored on a digital ledger and/or immutable sequential listing. “Cryptocurrency,” as used in this disclosure, is a digital or virtual currency that is secured by cryptography. This makes it nearly impossible to counterfeit or double-spend. In some embodiments, cryptocurrencies are decentralized networks based on blockchain technology such as immutable sequential listing enforced by a network of computing devices. In some embodiments, apparatus 100 may allow various types of cryptocurrency such as Ethereum (ETH), Litecoin (LTC), Cardano (ADA), Polkadot (DOT), Bitcoin Cash (BCH), Stellar (XLM), and the like thereof. Persons skilled in the art, upon reviewing the entirety of this disclosure, will be aware of the various embodiments of different types of money for purposes as described herein. Decentralized fiat 128 may be associated with reproducible digital files such as photos, videos, and audio. Decentralized fiat 128 may also be associated with physical assets such as real estate, collectables, and other commodities. In an embodiment, processor 104 may issue a certificate of completion after a user has achieved a skill target 112 or a pecuniary target 116. Decentralized fiat 128 may be used to represent a certificate of completion. Possession or payment of decentralized fiat 128 may serve as proof that the user has accomplished all or a portion of a user a skill target 112 or a pecuniary target 116. A user may be paid in a decentralized fiat 128 as completion of a posting 120. In embodiments, the time and level of difficulty for the user to achieve a skill target 112 or a pecuniary target 116 may be demonstrated by the value of decentralized fiat 128. The creator may “tokenize” such assets to be stored on a digital ledger and/or immutable sequential listing, which may ensure non-duplicability and ownership, generate income, and/or enable accessibility of the assets. Persons skilled in the art, upon reviewing the entirety of this disclosure, will be aware of the various embodiments and purposes of tokenizing an asset.

With continued reference to FIG. 1, posting 120, skill datum 108, skill target 112, pecuniary target 116, wage index, skill rank, geographical datum, cohort datum, expert datum, and the like may be displayed using a graphical user interface (GUI) 132. As used in the current disclosure, a “graphical user interface” may include a plurality of lines, images, symbols. GUI 132 may be displayed on a display device. Display device may include, but is not limited to, a smartphone, tablet, laptop, monitor, tablet, and the like. Display device may include a separate device that includes a transparent screen configured to display computer generated images and/or information. The user may view the information displayed on the display device in real time.

With continued reference to FIG. 1, apparatus 100 may perform or implement one or more aspects of a cryptographic system. In one embodiment, a cryptographic system is a system that converts data from a first form, known as “plaintext,” which is intelligible when viewed in its intended format, into a second form, known as “ciphertext,” which is not intelligible when viewed in the same way. Ciphertext may be unintelligible in any format unless first converted back to plaintext. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key.

With continued reference to FIG. 1, in embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=−R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

With continued reference to FIG. 1, in some embodiments, systems and methods described herein produce cryptographic hashes, also referred to by the equivalent shorthand term “hashes.” A cryptographic hash, as used herein, is a mathematical representation of a lot of data, such as files or blocks in a block chain as described in further detail below; the mathematical representation is produced by a lossy “one-way” algorithm known as a “hashing algorithm.” Hashing algorithm may be a repeatable process; that is, identical lots of data may produce identical hashes each time they are subjected to a particular hashing algorithm. Because hashing algorithm is a one-way function, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

With continued reference to FIG. 1, in an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, SHA256, a NIST standard; further current and past hashing algorithms include Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Polyl305-AES, Elliptic Curve Only Hash (“ECOH”) and similar hash functions, Fast-Syndrome-based (FSB) hash functions, GOST hash functions, the Grostl hash function, the HAS-160 hash function, the JH hash function, the RadioGatUn hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2^{n/2}) for n output bits; thus, it may take on the order of 2²⁵⁶ operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

Continuing to refer to FIG. 1, a “secure proof,” as used in this disclosure, is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

With continued reference to FIG. 1, secure proof may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from a public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. in a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

With continued reference to FIG. 1, alternatively, zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup; as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

With continued reference to FIG. 1, a zero-knowledge proof may include any other suitable zero-knowledge proof. Zero-knowledge proof may include, without limitation bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (TOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

With continued reference to FIG. 1, in an embodiment, secure proof is implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation. A single key may be used in one or more digital signatures as described in further detail below, such as signatures used to receive and/or transfer possession of crypto-currency assets; the key may be discarded for future use after a set period of time. In an embodiment, varied inputs include variations in local physical parameters, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system, or using a private key of a symmetric cryptographic system; for instance, trusted party may verify response by decrypting an encryption of challenge or of another datum using either a symmetric or public-key cryptographic system, verifying that a stored key matches the key used for encryption as a function of at least a device-specific secret. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

With continued reference to FIG. 1, A “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described above, including without limitation encryption using a private key of a public key cryptographic system as described above. Signature may be verified using a verification datum suitable for verification of a secure proof; for instance, where secure proof is enacted by encrypting message using a private key of a public key cryptographic system, verification may include decrypting the encrypted message using the corresponding public key and comparing the decrypted representation to a purported match that was not encrypted; if the signature protocol is well-designed and implemented correctly, this means the ability to create the digital signature is equivalent to possession of the private decryption key and/or device-specific secret. Likewise, if a message making up a mathematical representation of file is well-designed and implemented correctly, any alteration of the file may result in a mismatch with the digital signature; the mathematical representation may be produced using an alteration-sensitive, reliably reproducible algorithm, such as a hashing algorithm as described above. A mathematical representation to which the signature may be compared may be included with signature, for verification purposes; in other embodiments, the algorithm used to produce the mathematical representation may be publicly available, permitting the easy reproduction of the mathematical representation corresponding to any file.

Still viewing FIG. 1, in some embodiments, digital signatures may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. The digital certificate may include a digital signature.

With continued reference to FIG. 1, in some embodiments, a third party such as a certificate authority (CA) is available to verify that the possessor of the private key is a particular entity; thus, if the certificate authority may be trusted, and the private key has not been stolen, the ability of an entity to produce a digital signature confirms the identity of the entity and links the file to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include a skill target 112 or pecuniary target 116 as described above as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

For example, and still referring to FIG. 2, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, a node may include, without limitation a plurality of inputs xi that may receive numerical values from inputs to a neural network containing the node and/or from other nodes. Node may perform a weighted sum of inputs using weights wᵢ that are multiplied by respective inputs x. Additionally or alternatively, a bias b may be added to the weighted sum of the inputs such that an offset is added to each unit in the neural network layer that is independent of the input to the layer. The weighted sum may then be input into a function co, which may generate one or more outputs y. Weight wᵢ applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

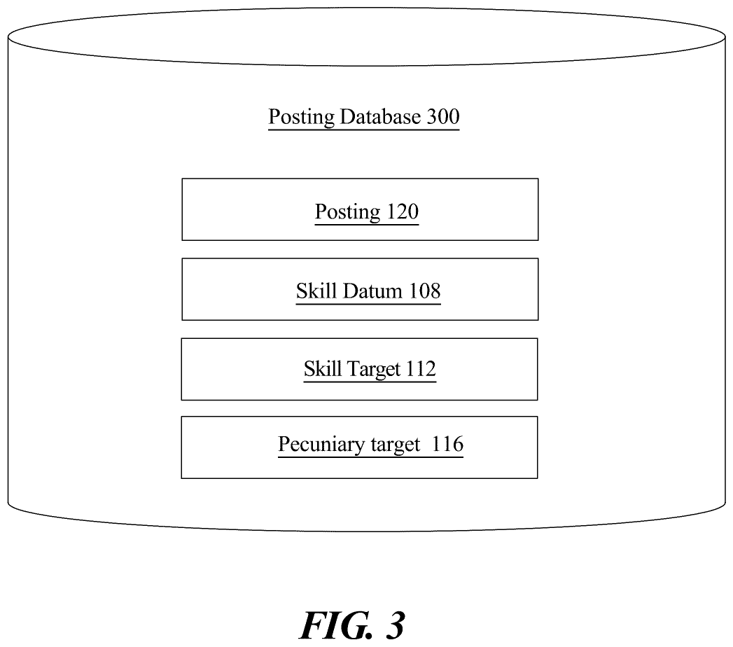

Now referring to FIG. 3, an exemplary posting database 300 is illustrated by way of block diagram. In an embodiment, posting 120, skill datum 108, skill target 112, pecuniary target 116, wage index, skill rank, geographical datum, cohort datum, expert datum, and the like may be stored in a posting database 300 (also referred to as “database”). Processor 104 may be communicatively connected with posting database 300. For example, in some cases, database 300 may be local to processor 104. Alternatively or additionally, in some cases, database 300 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connect directly, dynamically, and non-hierarchically to as many other computing devices as possible. A “network topology” as used in this disclosure is an arrangement of elements of a communication network. Posting database 300 may be implemented, without limitation, as a relational database, a key-value retrieval database such as a NOSQL database, or any other format or structure for use as a database that a person skilled in the art would recognize as suitable upon review of the entirety of this disclosure. Posting database 300 may alternatively or additionally be implemented using a distributed data storage protocol and/or data structure, such as a distributed hash table or the like. Posting database 300 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

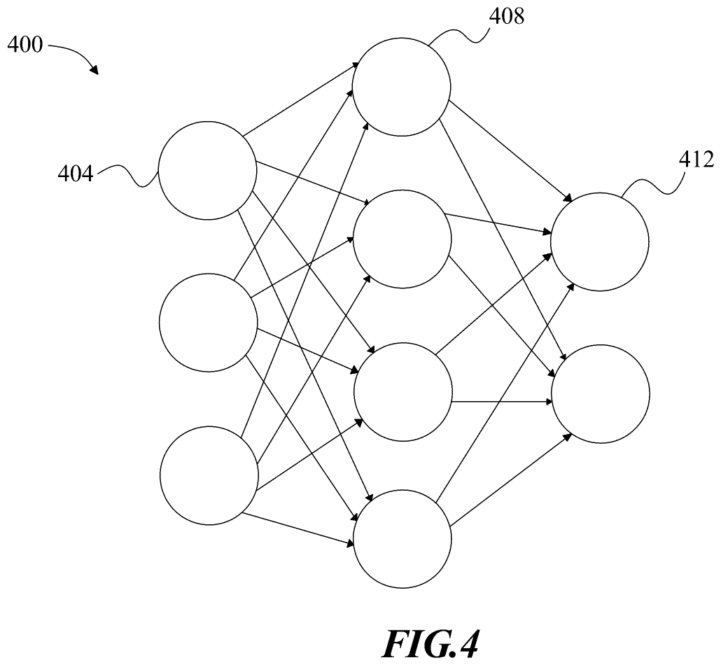

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

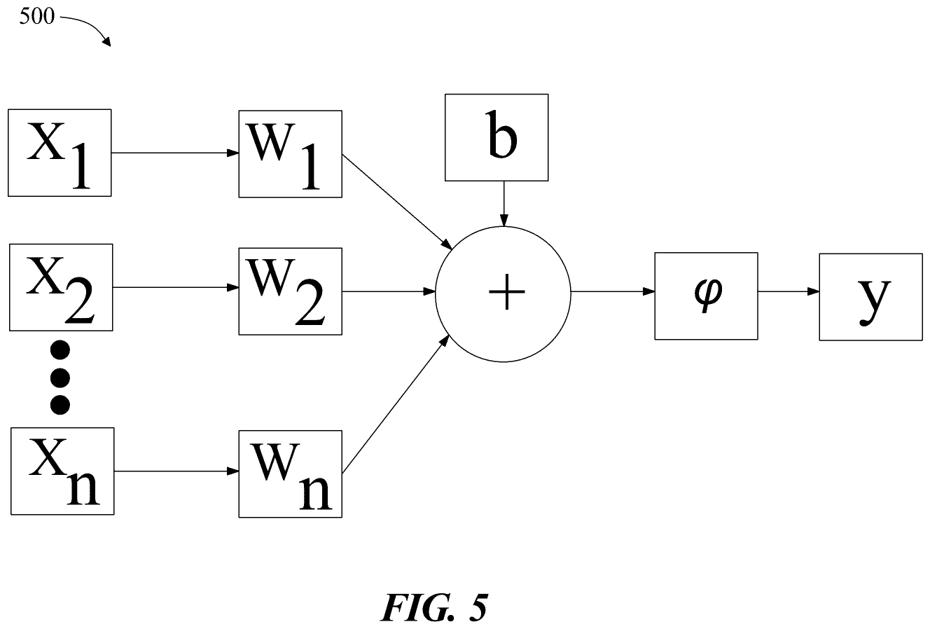

Referring now to FIG. 5, an exemplary embodiment of a node of a neural network is illustrated. A node may include, without limitation a plurality of inputs xi that may receive numerical values from inputs to a neural network containing the node and/or from other nodes. Node may perform a weighted sum of inputs using weights wᵢ that are multiplied by respective inputs xi. Additionally or alternatively, a bias b may be added to the weighted sum of the inputs such that an offset is added to each unit in the neural network layer that is independent of the input to the layer. The weighted sum may then be input into a function co, which may generate one or more outputs y. Weight wᵢ applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

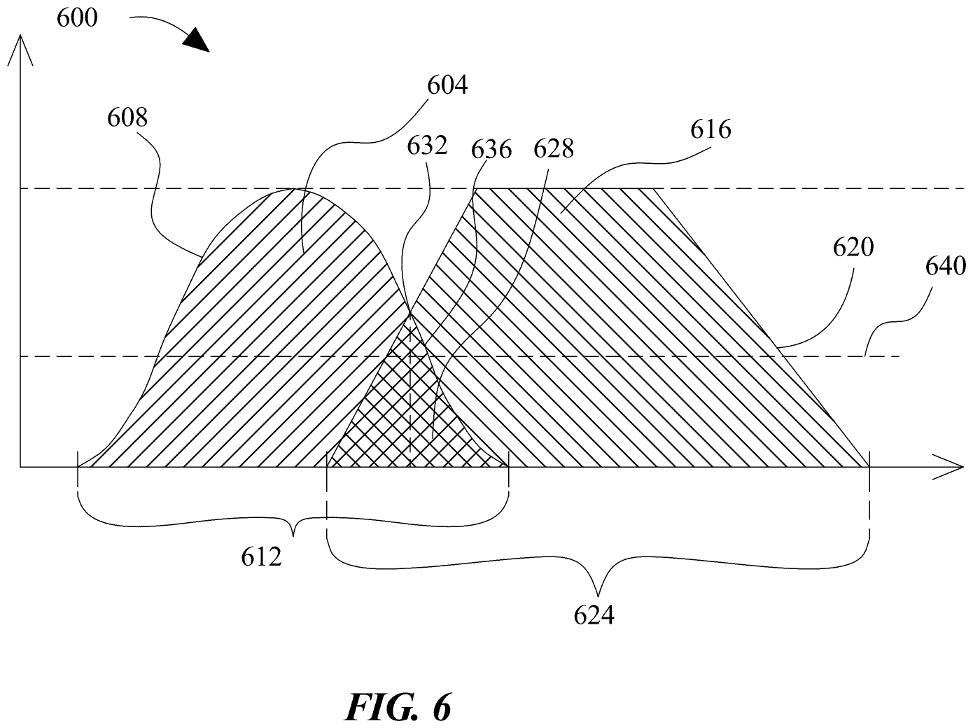

Now referring to FIG. 6, an exemplary embodiment of fuzzy set comparison 600 is illustrated. In a non-limiting embodiment, the fuzzy set comparison. In a non-limiting embodiment, fuzzy set comparison 600 may be consistent with fuzzy set comparison in FIG. 1. In another non-limiting the fuzzy set comparison 600 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent user skill target 112, pecuniary target 116, and posting 120 from FIG. 1.

Alternatively or additionally, and still referring to FIG. 6, fuzzy set comparison 600 may be generated as a function of determining data compatibility threshold. The compatibility threshold may be determined by a computing device. In some embodiments, a computing device may use a logic comparison program, such as, but not limited to, a fuzzy logic model to determine the compatibility threshold and/or version authenticator. Each such compatibility threshold may be represented as a value for a posting variable representing the compatibility threshold, or in other words a fuzzy set as described above that corresponds to a degree of compatibility and/or allowability as calculated using any statistical, machine-learning, or other method that may occur to a person skilled in the art upon reviewing the entirety of this disclosure. In some embodiments, determining the compatibility threshold and/or version authenticator may include using a linear regression model. A linear regression model may include a machine learning model. A linear regression model may map statistics such as, but not limited to, frequency of the same range of version numbers, and the like, to the compatibility threshold and/or version authenticator. In some embodiments, determining the compatibility threshold of any posting may include using a classification model. A classification model may be configured to input collected data and cluster data to a centroid based on, but not limited to, frequency of appearance of the range of versioning numbers, linguistic indicators of compatibility and/or allowability, and the like. Centroids may include scores assigned to them such that the compatibility threshold may each be assigned a score. In some embodiments, a classification model may include a K-means clustering model. In some embodiments, a classification model may include a particle swarm optimization model. In some embodiments, determining a compatibility threshold may include using a fuzzy inference engine. A fuzzy inference engine may be configured to map one or more compatibility threshold using fuzzy logic. In some embodiments, a plurality of computing devices may be arranged by a logic comparison program into compatibility arrangements. A “compatibility arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given compatibility threshold and/or version authenticator, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 6, inference engine may be implemented according to input and/or output skill target 112, pecuniary target 116, and posting 120. For instance, an acceptance variable may represent a first measurable value pertaining to the classification of skill target 112 and pecuniary target 116 to a posting 120. Continuing the example, an output variable may represent a posting 120 specific the current user. In an embodiment, skill target 112 and pecuniary target 116 may be represented by their own fuzzy set. In other embodiments, a posting 120 specific to the user may be represented as a function of the intersection two fuzzy sets as shown in FIG. 6, An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 604 may represent any value or combination of values as described above, including any software component datum, any source repository datum, any malicious quantifier datum, any predictive threshold datum, any string distance datum, any resource datum, any niche datum, and/or any combination of the above. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 636 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, an achievable posting 120 may indicate a sufficient degree of overlap with the skill target 112 and pecuniary target 116 for combination to occur as described above. There may be multiple thresholds; for instance, a second threshold may indicate a sufficient match for purposes of past posting and posting query as described in this disclosure. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both skill target 112 and pecuniary target 116 have fuzzy sets, a skill target 112 and pecuniary target 116 may be matched to a posting 120 by having a degree of overlap exceeding a predictive threshold, processor 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

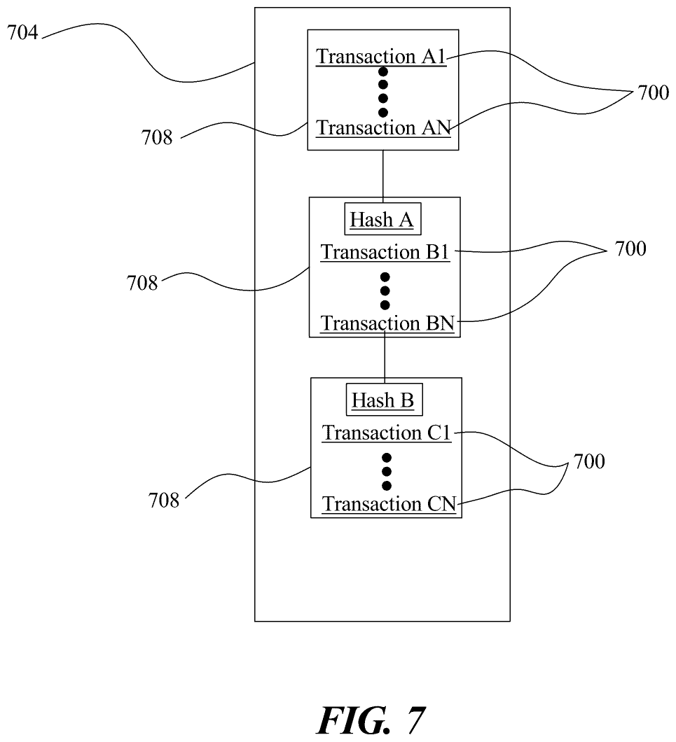

Referring now to FIG. 7, an exemplary embodiment of an immutable sequential listing is illustrated. An “immutable sequential listing,” as used in this disclosure, is a data structure that places data entries in a fixed sequential arrangement, such as a temporal sequence of entries and/or blocks thereof, where the sequential arrangement, once established, cannot be altered, or reordered. An immutable sequential listing may be, include and/or implement an immutable ledger, where data entries that have been posted to the immutable sequential listing cannot be altered. Data elements are listing in immutable sequential listing; data elements may include any form of data, including textual data, image data, encrypted data, cryptographically hashed data, and the like. Data elements may include, without limitation, one or more at least a digitally signed assertions. In one embodiment, a digitally signed assertion 704 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 704. In an embodiment, collection of textual data states that the owner of a certain transferable item represented in a digitally signed assertion 704 register is transferring that item to the owner of an address. A digitally signed assertion 704 may be signed by a digital signature created using the private key associated with the owner's public key, as described above.

Still referring to FIG. 7, a digitally signed assertion 704 may describe a transfer of virtual currency, such as crypto-currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g. a ride share vehicle or any other asset. A digitally signed assertion 704 may describe the transfer of a physical good; for instance, a digitally signed assertion 704 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 704 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 7, in one embodiment, an address is a textual datum identifying the recipient of virtual currency or another item of value in a digitally signed assertion 704. In some embodiments, address is linked to a public key, the corresponding private key of which is owned by the recipient of a digitally signed assertion 704. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 704 may record a subsequent a digitally signed assertion 704 transferring some or all of the value transferred in the first a digitally signed assertion 704 to a new address in the same manner. A digitally signed assertion 704 may contain textual information that is not a transfer of some item of value in addition to, or as an alternative to, such a transfer. For instance, as described in further detail below, a digitally signed assertion 704 may indicate a confidence level associated with a distributed storage node as described in further detail below.

In an embodiment, and still referring to FIG. 7 immutable sequential listing records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 7, immutable sequential listing may preserve the order in which the at least a posted content took place by listing them in chronological order; alternatively or additionally, immutable sequential listing may organize digitally signed assertions 704 into sub-listings 708 such as “blocks” in a blockchain, which may be themselves collected in a temporally sequential order; digitally signed assertions 704 within a sub-listing 708 may or may not be temporally sequential. The ledger may preserve the order in which at least a posted content took place by listing them in sub-listings 708 and placing the sub-listings 708 in chronological order. The immutable sequential listing may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 7, immutable sequential listing, once formed, may be inalterable by any party, no matter what access rights that party possesses. For instance, immutable sequential listing may include a hash chain, in which data is added during a successive hashing process to ensure non-repudiation. Immutable sequential listing may include a block chain. In one embodiment, a block chain is immutable sequential listing that records one or more new at least a posted content in a data item known as a sub-listing 708 or “block.” An example of a block chain is the BITCOIN block chain used to record BITCOIN transactions and values. Sub-listings 708 may be created in a way that places the sub-listings 708 in chronological order and link each sub-listing 708 to a previous sub-listing 708 in the chronological order so that any computing device may traverse the sub-listings 708 in reverse chronological order to verify any at least a posted content listed in the block chain. Each new sub-listing 708 may be required to contain a cryptographic hash describing the previous sub-listing 708. In some embodiments, the block chain contains a single first sub-listing 708 sometimes known as a “genesis block.”

Still referring to FIG. 7, the creation of a new sub-listing 708 may be computationally expensive; for instance, the creation of a new sub-listing 708 may be designed by a “proof of work” protocol accepted by all participants in forming the immutable sequential listing to take a powerful set of computing devices a certain period of time to produce. Where one sub-listing 708 takes less time for a given set of computing devices to produce the sub-listing 708 protocol may adjust the algorithm to produce the next sub-listing 708 so that it will require more steps; where one sub-listing 708 takes more time for a given set of computing devices to produce the sub-listing 708 protocol may adjust the algorithm to produce the next sub-listing 708 so that it will require fewer steps. As an example, protocol may require a new sub-listing 708 to contain a cryptographic hash describing its contents; the cryptographic hash may be required to satisfy a mathematical condition, achieved by having the sub-listing 708 contain a number, called a nonce, whose value is determined after the fact by the discovery of the hash that satisfies the mathematical condition. Continuing the example, the protocol may be able to adjust the mathematical condition so that the discovery of the hash describing a sub-listing 708 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 708 according to the protocol is known as “mining.” The creation of a new sub-listing 708 may be designed by a “proof of stake” protocol as will be apparent to those skilled in the art upon reviewing the entirety of this disclosure.

Continuing to refer to FIG. 7, in some embodiments, protocol also creates an incentive to mine new sub-listings 708. The incentive may be financial; for instance, successfully mining a new sub-listing 708 may result in the person or entity that mines the sub-listing 708 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 708 Each sub-listing 708 created in immutable sequential listing may contain a record or at least a posted content describing one or more addresses that receive an incentive, such as virtual currency, as the result of successfully mining the sub-listing 708.

Still referring to FIG. 1, processor may be configured to generate a machine learning model, such as posting machine learning model 124, using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 7, where two entities simultaneously create new sub-listings 708, immutable sequential listing may develop a fork; protocol may determine which of the two alternate branches in the fork is the valid new portion of the immutable sequential listing by evaluating, after a certain amount of time has passed, which branch is longer. “Length” may be measured according to the number of sub-listings 708 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 708 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing.

Still referring to FIG. 7, additional data linked to at least a posted content may be incorporated in sub-listings 708 in the immutable sequential listing; for instance, data may be incorporated in one or more fields recognized by block chain protocols that permit a person or computer forming a at least a posted content to insert additional data in the immutable sequential listing. In some embodiments, additional data is incorporated in an unspendable at least a posted content field. For instance, the data may be incorporated in an OP RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 7, in some embodiments, virtual currency is traded as a crypto-currency. In one embodiment, a crypto-currency is a digital, currency such as Bitcoins, Peercoins, Namecoins, and Litecoins. Crypto-currency may be a clone of another crypto-currency. The crypto-currency may be an “alt-coin.” Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger, as in the case of the), (RF. currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 708 in a block chain computationally challenging; the incentive for producing sub-listings 708 may include the grant of new crypto-currency to the miners. Quantities of crypto-currency may be exchanged using at least a posted content as described above.

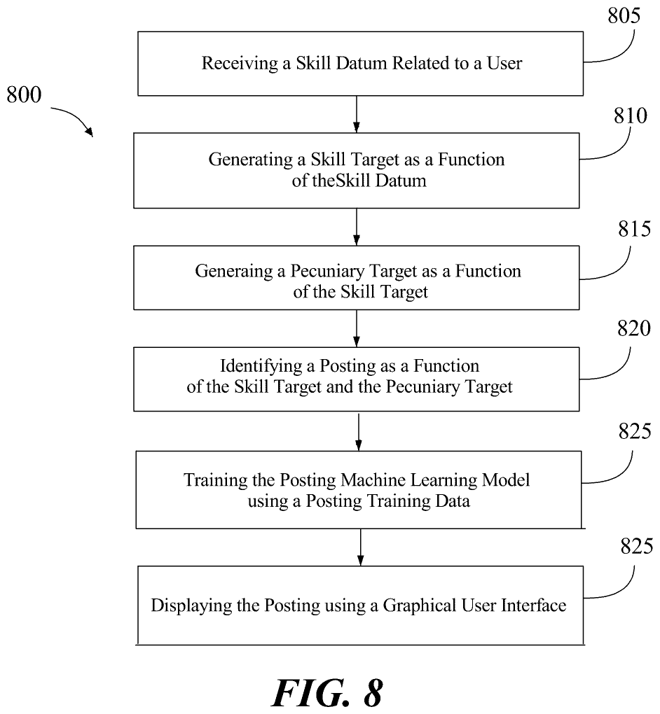

Referring to FIG. 8, an exemplary method 800 for posting identification. Method 800 incudes a step 805, of receiving, using a processor, a skill datum related to a user, wherein skill datum is comprised of the current skill of the user. This may occur as described above in reference to FIGS. 1-8. In an embodiment, a skill improvement datum may be generated as function of the skill datum. In another embodiment, a skill rank may be generated as a function of the skill datum. The posting may be identified as a function of the skill rank. In an embodiment, the skill datum is generated using a plurality of sensors or a wearable device.

With continued reference to FIG. 8, method 800 includes a step 810 of generating, using a processor, a skill target as a function of the skill datum. This may occur as described above in reference to FIGS. 1-8.

With continued reference to FIG. 8, method 800 includes a step 815 of generating, using a processor, a pecuniary target of the user as a function of the skill target. This may occur as described above in reference to FIGS. 1-8.

With continued reference to FIG. 8, method 800 includes a step 820 of identifying, using a processor, a posting as a function of the skill target and the pecuniary target. This may occur as described above in reference to FIGS. 1-8. In an embodiment, a decentralized fiat is generated as a function of completion the posting. In an embodiment, the posting is identified as a function of a geographic datum.

With continued reference to FIG. 8, method 800 includes a step 825 of training, using a processor, the posting machine learning model using a posting training data, wherein the posting training data contains a plurality of data entries containing a plurality of skill targets and a plurality of pecuniary targets as inputs correlated to a plurality of postings as a output. This may occur as described above in reference to FIGS. 1-8.

With continued reference to FIG. 8, method 800 includes a step 830 of displaying, using a processor, the posting using a graphical user interface. This may occur as described above in reference to FIGS. 1-8.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

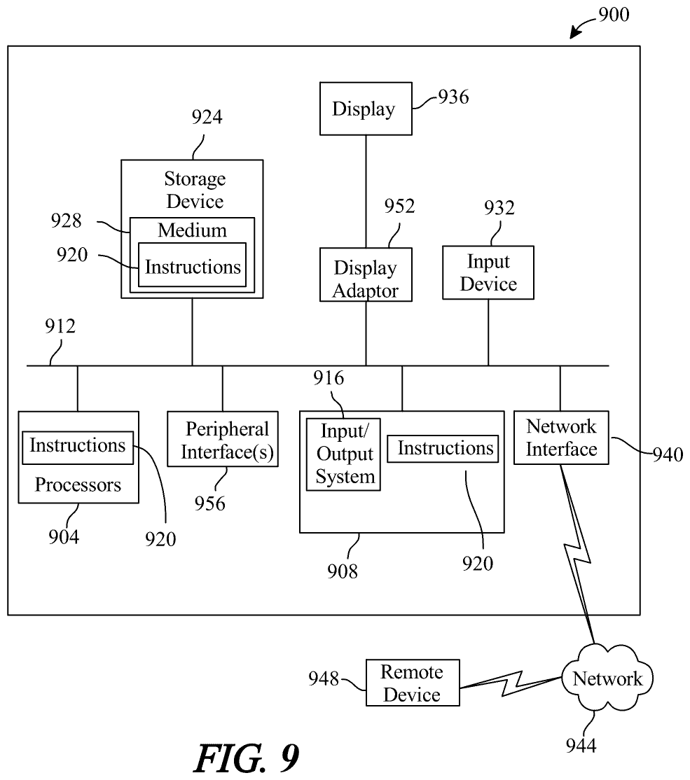

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

1. An apparatus for task identification, wherein the apparatus comprises:
at least a sensor, wherein the at least a sensor is configured to detect a skill datum;
at least a processor communicatively connected to the at least a sensor; and
a memory communicatively connected to the at least a processor, the memory containing instructions configuring the at least a processor to:
receive a skill datum related to a user from the at least a sensor, wherein skill datum comprises a datum describing a current skill of the user;
generate a skill target as a function of the skill datum; wherein the skill target is generated by:
receiving target training data correlating a plurality of skill datum to a plurality of skill targets including an improvement of academic skill;
training a target machine learning model using the target training data wherein training the target machine learning model comprises:
iteratively updating the target training data as a function of the input and output results of the target machine learning model; and
retraining the target machine learning model with an updated target training data;
inputting the skill datum to the trained target machine learning model; and
outputting the skill target, corresponding to the improvement of academic skill, from the trained target machine learning model;
generate a pecuniary target of the user as a function of the skill target;
identify a posting as a function of the skill target and the pecuniary target, wherein identifying the posting comprises:
receiving posting training data correlating a plurality of skill targets and a plurality of pecuniary targets to a plurality of postings;
training a posting machine learning model using the posting training data;
inputting the skill target and the pecuniary target to the trained posting machine learning model; and
outputting the posting from the trained posting machine learning model;
generate a decentralized fiat as a function of the identification of the posting, wherein the decentralized fiat comprises a non-fungible token; and
display the posting and the decentralized fiat using a graphical user interface.

2. The apparatus of claim 1, further configured to generate a skill improvement datum as a function of the skill datum.

3. The apparatus of claim 1, further configured to generate a skill rank as a function of the skill datum.

4. The apparatus of claim 3, wherein identifying the posting further comprises identifying the posting as a function of the skill rank.

5. (canceled)

6. The apparatus of claim 1, wherein identifying the posting further comprises identifying the posting as a function of a geographic datum.

7. The apparatus of claim 1, wherein identifying the posting further comprises identifying the posting as a function of a cohort datum.

8. The apparatus of claim 1, wherein identifying the posting further comprises identifying the posting as a function of an expert datum.

9. The apparatus of claim 1, further configured to generate the skill datum using a plurality of sensors.

10. The apparatus of claim 1, further configured to generate the skill datum using a wearable device.

11. A method for posting identification, wherein the method comprises:
detecting, by a sensor, a skill datum
receiving, using a processor communicatively connected to the sensor, a skill datum related to a user, wherein skill datum comprises a datum describing a current skill of the user;
generating, using the processor, a skill target as a function of the skill datum;
wherein the skill target is generated by:
receiving target training data correlating a plurality of skill datum to a plurality of skill targets including an improvement of academic skill;
training a target machine learning model using the target training data, wherein:
iteratively updating the target training data as a function of the input and output results of the target machine learning model; and
retraining the target machine learning model with an updated target training data;
inputting the skill datum to the trained target machine learning model; and
outputting the skill target corresponding to the improvement of academic skill from the trained target machine learning model;
generating, using a processor, a pecuniary target of the user as a function of the skill target;
identifying, using a processor, a posting as a function of the skill target, the pecuniary target, wherein identifying the posting comprises:
receiving posting training data correlating a plurality of skill targets and a plurality of pecuniary targets to a plurality of postings;
training, using a processor, a posting machine learning model using the posting training data;
inputting the skill target and the pecuniary target to the trained posting machine learning model; and
outputting the postings from the trained posting machine learning model;
generating, using the processor, a decentralized fiat as a function of the identification of the posting, wherein the decentralized fiat comprises a non-fungible token; and
displaying, using a processor, the posting and the decentralized fiat using a graphical user interface.

12. The method of claim 11, further comprising generating a skill improvement datum as a function of the skill datum.

13. The method of claim 11, further configured to generate a skill rank as a function of the skill datum.

14. The method of claim 13, wherein identifying the posting further comprises identifying the posting as a function of the skill rank.

15. (canceled)

16. The method of claim 11, wherein identifying the posting further comprises identifying the posting as a function of a geographic datum.

17. The method of claim 11, wherein identifying the posting further comprises identifying the posting as a function of a cohort datum.

18. The method of claim 11, wherein identifying the posting further comprises identifying the posting as a function of an expert datum.

19. The method of claim 11, further configured to generate the skill datum using a plurality of sensors.

20. The method of claim 11, further configured to generate the skill datum using a wearable device.

21. The system of claim 1, wherein training the target machine learning model further comprises:
generating a numerical value reflective of the inputs and outputs of the target machine learning model;
assign connections and weights between nodes in adjacent layers of the target machine learning model as a function of the numerical value; and
adjusting using inputs in the target training data to produce correlated desired outputs in the training data.

22. The method of claim 11, wherein training the target machine learning model further comprises:
generating a numerical value reflective of the inputs and outputs of the target machine learning model;
assign connections and weights between nodes in adjacent layers of the target machine learning model as a function of the numerical value; and
adjusting using inputs in the target training data to produce correlated desired outputs in the training data.
